(19) United States
(12) Patent Application Publication
(10) Pub. No.: US 2015/0019941 A1
(43) Pub. Date: Jan. 15, 2015

(54) Apparatus For Presence Documentation and Asset Chemistry!

(71) Applicant: Howard Gutowitz, New York, NY (US)

(72) Inventor: Howard Gutowitz, New York, NY (US)

(21) Appl. No.: 14/328,675

(22) Filed: Jul. 10, 2014

Related U.S. Application Data
(60) Provisional application No. 61/844,592, filed on Jul. 10, 2013.

(51) Int. Cl. G06F 3/0484; G06F 3/0488

(52) U.S. Cl. CPC G06F 3/04842; G06F 3/0488
USPC 715/202

(57) ABSTRACT

Telling a story in general, and about one's present situation in particular, may involve the creation and arrangement of many kinds of media assets, including but not limited to text, images, videos, sounds. Especially when the story to be told involves documenting the fluctuating and shifting present state of the user, which medium is best suited to the moment may fluctuate and shift along with that user state. In some aspects, the present invention opens several streams of data collection simultaneously, allowing the user to rapidly and efficiently shift between modes of self expression and documentation of their environment.

Whether assets are captured in the moment or not, it may be desirable to automatically combine these assets into a coherent narrative structure and/or a reduced set of media types. In some aspects, the invention provides mechanisms provides mechanisms to build a compelling and unified final product representing the user's present state, with a high degree of production value, and little or no intervention of user in the construction of the final product from the pieces they have collected.

### RELATED APPLICATIONS

This application relates to, and claims the benefit of the filing date of co-pending U.S. provisional patent application Ser. No. 61/844,592 entitled Apparatus for Presence Documentation and Asset Chemistry, filed Jul. 10, 2013, the entire contents of which are incorporated herein by reference for all purposes.

### BACKGROUND OF THE INVENTION

Telling a story may involve the creation and arrangement of many kinds of media assets, including but not limited to text, images, videos, sounds. What has not been appreciated up to now is that, especially when the story to be told involves documenting the fluctuating and shifting present state of the user, which medium is best suited to the moment may fluctuate and shift along with that user state. Prior art devices frustrate presence documentation by erecting rigid, cumbersome and unsuitable control structures which impede the collection of media for variegated sources by forcing the user to constantly intervene to adjust the state of the media collection device to adapt to their changing desired means of capture. The present invention, by contrast, opens several streams of data collection simultaneously, allowing the user to rapidly and efficiently shift between modes of self expression and documentation of their environment.

Whether assets are captured in the moment or not, it may be desirable to combine these assets into a single narrative structure, or a few narrative structures. Various aspects of exemplary embodiments presented in detail herein have inventive features for performing such combination.

### BRIEF DESCRIPTION OF THE DRAWINGS

The various aspects and features of the invention will be described in reference to a set of drawings, brief descriptions of which follow.

FIG. 1 An illustrative embodiment comprising a touch screen, displaying a image feed on a first portion along with a simultaneously displayed keyboard on a second portion.

FIG. 2 An illustrative embodiment comprising a camera which may selectable supply an image feed.

FIG. 3 An illustrative state of an embodiment in which the keyboard has been dismissed.

FIG. 4 An illustrative state of an embodiment in which the image feed display surrounds the keyboard.

FIG. 5 An illustrative embodiment comprising a microphone.

FIG. 6 Illustrative flow chart of session-based asset collection.

FIG. 7 Illustrative flow chart for a single control which can take an image or a video depending on how long it is held.

FIG. 8 An illustrative embodiment with access to a basket.

FIG. 9 An illustrative embodiment of a UI for an open basket.

FIG. 10 An illustrative embodiment of an alternate UI for an open basket.

FIG. 11 Illustrative combining behavior of assets and sub-baskets in a combining basket.

FIG. 12 Illustrative creation and operation of a basket hierarchy.

FIG. 13 An illustrative set of asset combining rules.

FIG. 14 An alternate illustrative set of asset combining rules.

FIG. 15 A basket hierarchy containing assets.

FIG. 16 The basket hierarchy of FIG. 15, after the collapse of level 2.

FIG. 17 The basket hierarchy of FIG. 15 after the collapse of levels 1 and 2.

FIG. 18 The basket hierarchy of FIG. 15 after the collapse of levels 1 and 2, and the combination of combinable assets at level 0.

FIG. 19 A user interface for viewing and manipulation within a single basket.

FIG. 20 Illustration of the creation of a sub-basket by dragging and dropping an asset icon onto another.

FIG. 21 A user interface for viewing and manipulation within a hierarchy of baskets.

### DETAILED SPECIFICATION

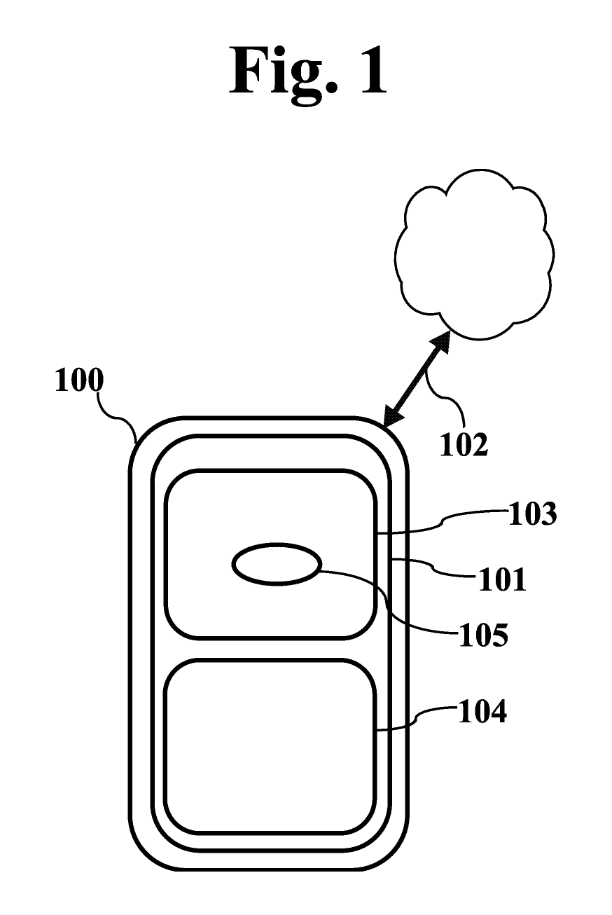

The first embodiment to be taught will be discussed in reference to FIG. 1, to which we now turn. FIG. 1 shows an apparatus [100] comprising a touch screen [101], a central processing unit (not shown), an activatable internet connection [102], which permits a state in which said touch screen [101] displays a image feed on a first portion of said touch screen [103] along with a simultaneously displayed keyboard on a second portion of said touch screen [104], and further comprising a control [105] such that using said control, a user can take a time slice from said image feed displayed in said first portion of said touch screen [103], to be combined with text, if any, entered with said simultaneously displayed keyboard in said second portion of said screen [104], said time slice and said text packaged by a packager (not shown) operating in said central processing unit for sending via said internet connection [102] and then sent via said internet connection [102] at a point in time where said internet connection is active.

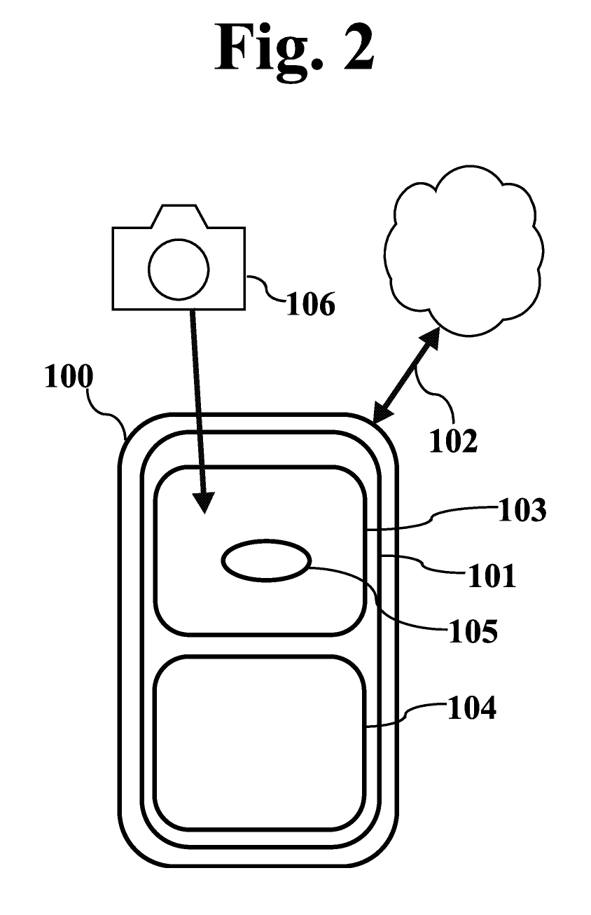

Note that the image feed could a priori be from either a stored source, e.g. a video recording, or from a real time feed, such as a camera, as will be discussed further in reference to FIG. 2. The time slice could be an instantaneous slice (a photograph), or a continuous segment of time (a video), or some intermediate slice such as a panorama (a non-instantaneous time slice rendered as a single image) or a burst of single photographs taken in rapid succession over a time period, etc. Also note that the control [105], schematically represented as a button in FIG. 1, might be activated by some gesture other than a tap, such as a swipe, might not be localized within the same said first portion of said touch screen [103] as the display of said image feed, and, might include the entire touch sensitive portion of said touch screen which is not devoted to other controls, or just the entire portion of said first portion of said touch screen. Indeed, said first portion [103] could have the same extent. The control [105] might even be a button or other gesture sensitive region distinct from the touch screen [103]. All of these variants are well within the scope of the appended claims as well as many other variants which might now be appreciated by one skilled in the art in view of the teachings herein disclosed.

Turning then to FIG. 2, we consider an apparatus which like that of FIG. 1, comprises the components [100-105] and which further comprises a camera [106]. This camera [106] could be integrated as part of the apparatus [100] or be physically distinct from it. For instance, if the apparatus [100] were a handheld device, the camera could be worn elsewhere by the user, say in their eyeglasses, or even be a security camera nowhere near the user and communicating with the apparatus [100] via a wired or wireless communication channel. When the apparatus [100] is designed specifically for documentation of personal presence, or at least currently used to that end, it is desirable for the camera to be near the user to be able to record that which the user can see at the moment of documentation. As shown in FIG. 2 the camera [106] feeds its images to the apparatus [100] to be displayed in the first portion [103] of the touch screen [101].

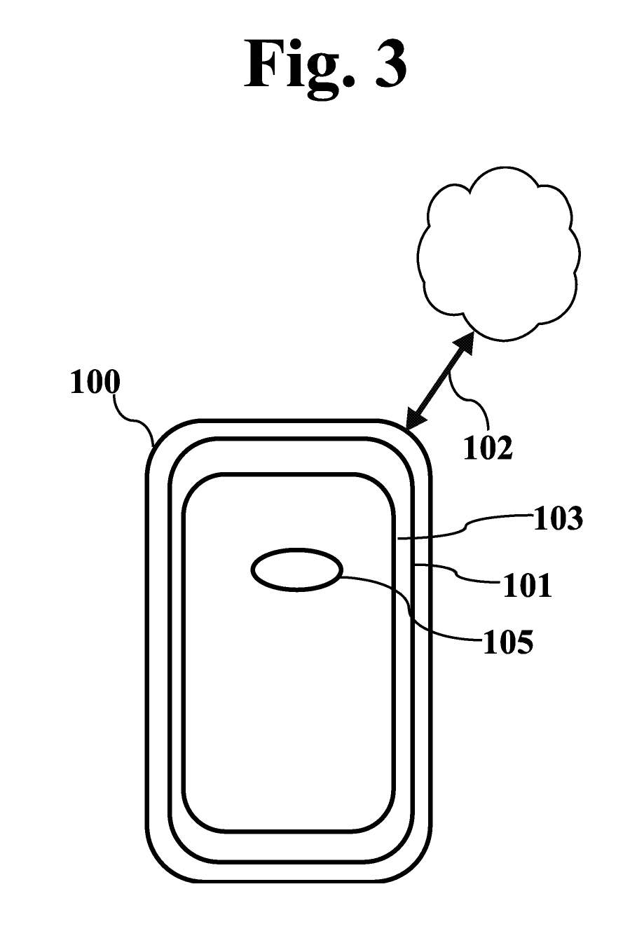

Turning now to FIG. 3, we see a diagrammatic illustration of how the apparatus [100] might appear when its keyboard [104] is suppressed. In this state, the apparatus [100] may still be used to capture time slices from the image feed, but cannot be simultaneously used to enter text via the keyboard. Text could still be input, potentially, using voice recognition. With the keyboard [104] suppressed, the image display portion [103] of the screen could grow to occupy all or part of the area previously devoted to the keyboard.

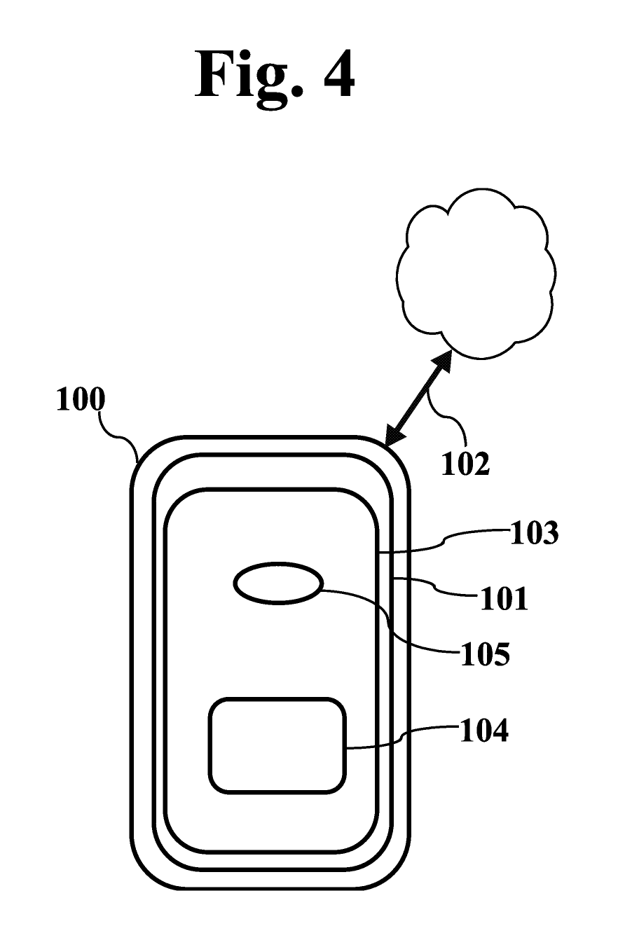

Turning now to FIG. 4, we see an alternate relationship between the portion of the portion of the touch screen displaying the image feed [103] and the portion of the screen displaying the keyboard [104]. In this case, the portion [104] is entirely contained with portion [103], both contained within the touch screen [101], itself contained in the apparatus [100], which communicates to the internet via [102], and contains a control for taking time slices [105]. That is, the keyboard is superimposed on the display of the image feed. The roles of these two areas could be reversed, with the image feed taking place entirely within the confines of the keyboard. Alternatively, the two areas [103] and [104] could partially overlap to various degrees.

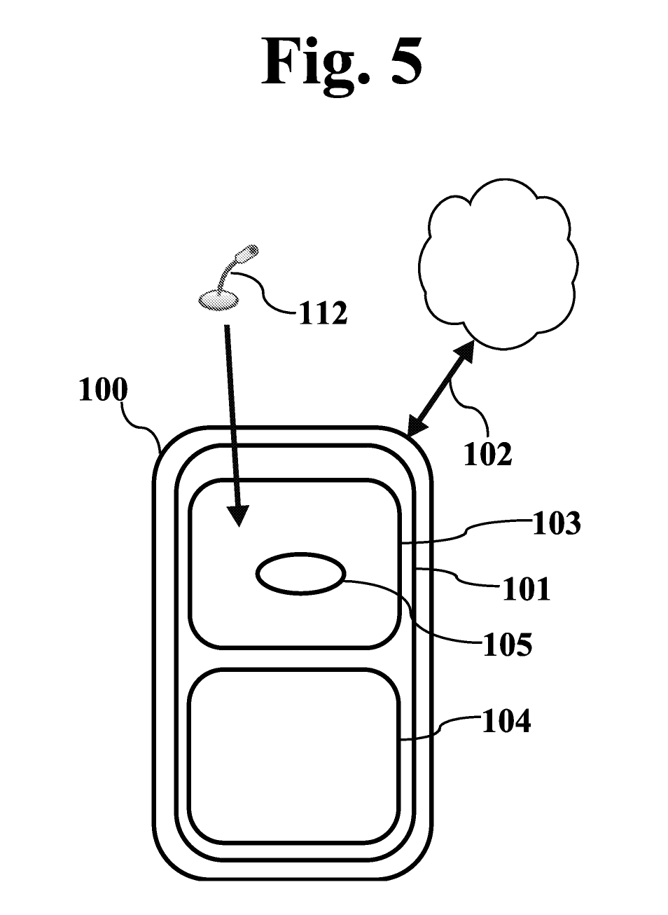

To further explore and illustrate the scope of the present claims, we turn now to FIG. 5 which shows how another kind of media asset, sound, can be time sliced according to the present invention. Here, an apparatus as illustrated in FIG. 1 further comprises a microphone [112]. Time slices from the input of this microphone could be taken using a variety of controls, depending on implementation. It could be activated, e.g. by a tap or swipe on the touch screen, or by some other button or gesture sensitive input. The microphone could be built into the apparatus [100] or physically distinct from it, communicating wired or wirelessly with the apparatus [100]. In an apparatus which also contains a video camera, the sound could be recorded by said video camera as a sound track for the video. The decision to use only the sound could be made at the time of starting the recording, or at some later stage of processing.

### Asset Accumulation Sessions

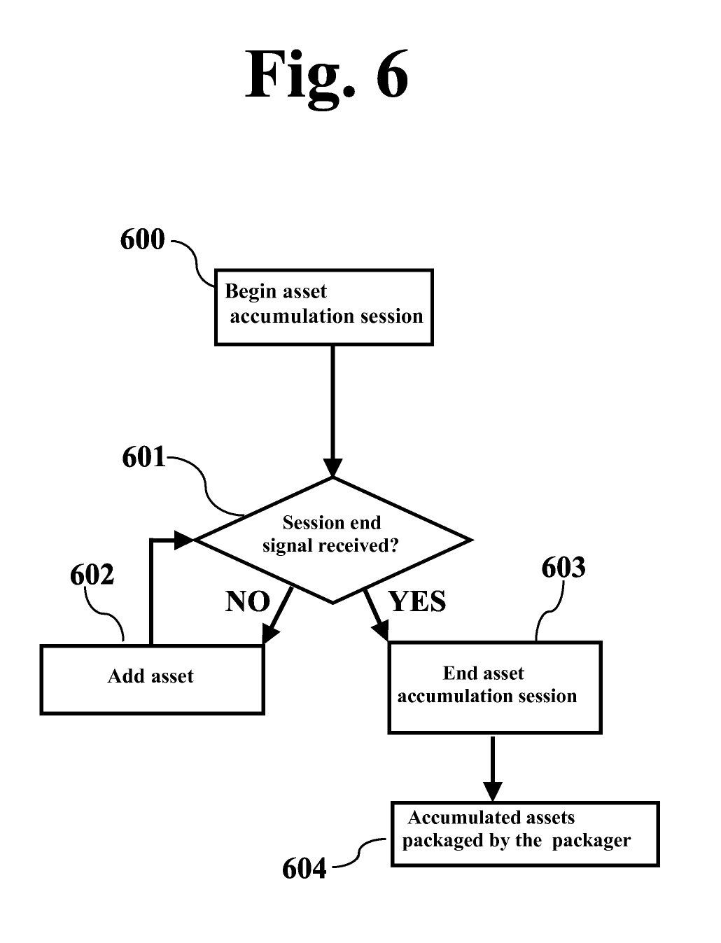

A typical use case of an apparatus according to the present disclosure is the creation of a message, comprising one or more finite time slices from one or more media streams, typically together with some text, the whole forming a message. Said message could be packaged as an email, tweet, blog post, SMS, or other message format, or packaged for uploading to a server to be distributed on a social media site, or a private file storage server. We now consider an embodiment which, in service of this use case, operates on a session basis. This operation will be described in reference to FIG. 6, to which we now turn. At step [600], an asset accumulation session begins. The signal for beginning the asset accumulation session may depend on the context in which the accumulated assets are to be used. For instance, in an email system, the sending of an email may signal the end of one asset accumulation session and the beginning of another, where all assets accumulated (and not deleted) during the composition of a given email are packaged for sending with that given email when that email is sent. In this case, pressing a “send” button could both end an asset accumulation session and begin a new one as well as initiating the sending of the email. In the case of an upload packaging, the “upload” signal could not only cause the uploading itself, but also end the current asset accumulation session and begin a new one, etc. Alternatively, separate controls could be used for beginning and ending asset accumulation sessions without reference to how the assets accumulated during a session are to be packaged or sent. In any implementation, at step [601], the session monitoring system checks whether a session-end signal has been received. If it has not, then, at step [602], the user may add a new asset for the current session. If a session end signal has been received, then the session ends at step [603], and the assets accumulated during that session are passed to the packager at step [604]. The packager is software which prepares the accumulated assets for their eventual destination. For instance, if the accumulated assets are to be sent as a tweet, the media assets such as pictures, sound recordings or videos will be uploaded to a web server, and links to the assets will be placed in the text to point to the uploaded assets. In the case of sending by email, the media assets might be mime encoded, and perhaps compressed or resized to meet any size restrictions pertaining to email. In short, the packager does whatever is required to prepare assets accumulated during the session for successful transmission to their ultimate destination.

### Multi-Functional Time Slice Control

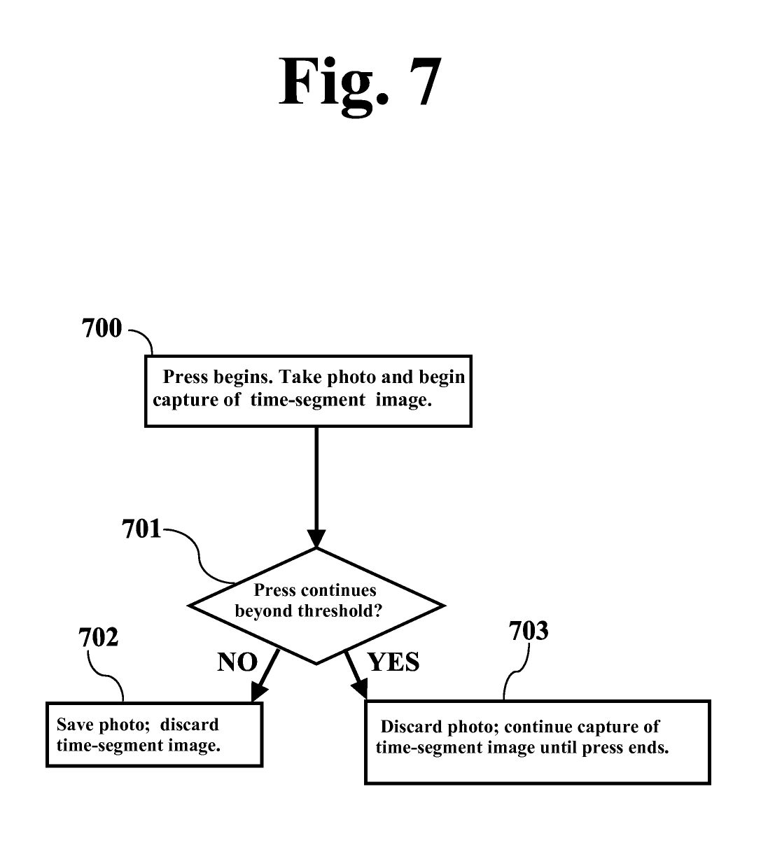

FIG. 7 presents an inventive time slice control which could be used, e.g. as the controller [105] of FIG. 1. This single control permits the user to take either photos (images at a single moment) or images taken over a segment of time, such as panoramas, videos, or bursts of photos. We will call such images taken over a segment of time “time-segment images” or simply “videos” when it is clear that the special case of video may stand for the set of time-segment images. While prior-art systems may include a button which takes both photos and time-segment images, the user must set the control to perform one or the other function beforehand. In the control of FIG. 7, by contrast, the ambiguity of which type of image is desired is determined on the fly, during use of the control, permitting the user to take different kinds of images in rapid succession. This is accomplished by interpreting a press of the button to be both the instruction to capture a photo, and to begin capturing a time-segment image, and discarding on or the other depending on how long the button is held. Specifically, at step [700] the user presses the button. Two things happen simultaneously: a) a photo is taken, and b) capture of a time-segment image begins. At step [701] it is determined if the press has been held beyond some threshold in time. A typical threshold would be on the order of hundreds of milliseconds. If the button is released in less time than the threshold (step [702]), then the capture of a time-segment image is terminated, and the partial time-segment image is discarded. Alternatively, if the press continues beyond the time threshold, then, at step [703], the photo is discarded and capture of the time-segment image continues until the button is released.

Note that the same control could be modified to take both photos and sound recordings, depending on how long the control is held.

### Speed Control

The control described above in reference to FIG. 7 could be enhanced to allow the user to control not only the time during with the video (or photo burst, or panorama or sound recording) is taken, but also the rate at which frames are recorded. In this embodiment, when the user moves their digit (finger or thumb) in one direction (preferably up) while continuing to hold and thus record, the rate of recording frames slows down, creating a perceived speed up during playback. When the user moves their digit in other direction (preferably down) the rate of recording frames speeds up, creating a perceived slow down during playback. The same gestures preferably have the opposite action during playback, e.g. moving up speeds up the rate of playback, and moving down slows the rate of playback. The same gestures and effects can be applied to sound recordings as well to variably change their rate during recording and/or playback.

Moving while holding could also be used to change modes to other time-segment functions. For instance, move right could switch to panorama mode, move left to photo burst mode, or sound recording mode. In the case of multiple available modes from a single gesture, it may be desirable to begin capture simultaneously in all available modes, as described above in relationship to FIG. 7. A control of this nature could be implemented in other hardware, such as a joy stick.

### Baskets

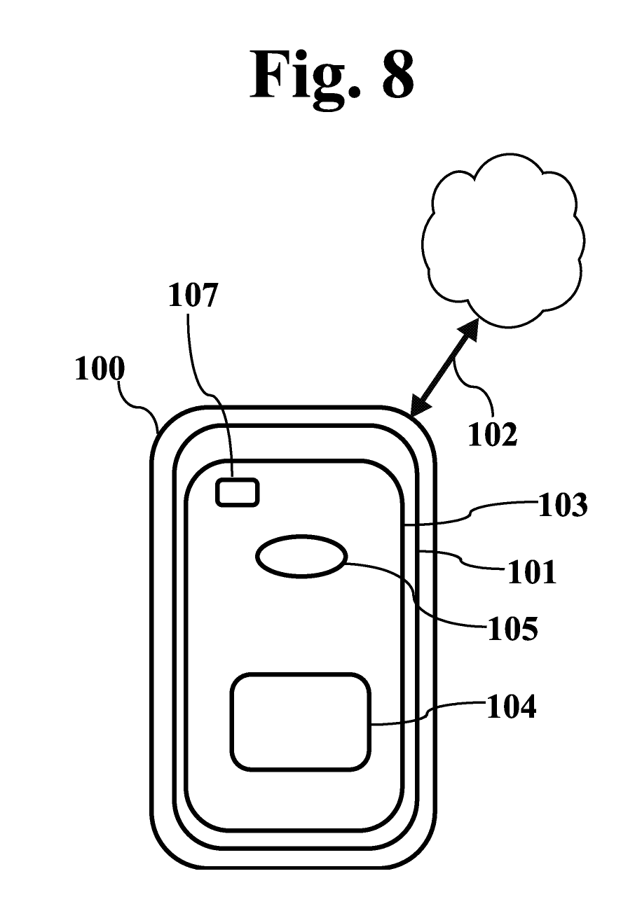

We will begin discussion of baskets in reference to FIG. 8, to which we now turn. FIG. 8 presents an illustrative embodiment similar to that of FIG. 1, and comprising the same features and aspects [100-105]. In addition, it contains a basket which is a utility which may permit the user to edit features of the assets collected during the present asset-collection session, and has other properties to be described further below. To access a basket in this embodiment, the user must perform some gesture. Preferably, that gesture is a press on the button [107] show in an illustrative location in FIG. 8. Preferably, this button displays a count of the assets collected into the basket during the current session. This count will be set back to 0 at the close of the session. In some implementations, the button [107] giving access to the basket may not appear at all until the basket contains at least one asset. Preferably also, various animations can be used to show assets captured during the current session entering the basket. In these animations, the button [107] is shown to be a portal into the basket into which various assets, such as images can “fall” upon creation. Text assets can be handled in various ways. One way is implicit: all text entered during the current session is to be packaged together with image and/or sound assets, if any, collected during the session. Another way is explicit: text is added to the basket bit by bit as it is typed in. For instance, the text box, where the text is displayed as it is type in, could be dragged and dropped into the button area [107] creating a text asset in the basket. In this preferred embodiment of a basket, pressing the button [107] opens the basket to show its contents.

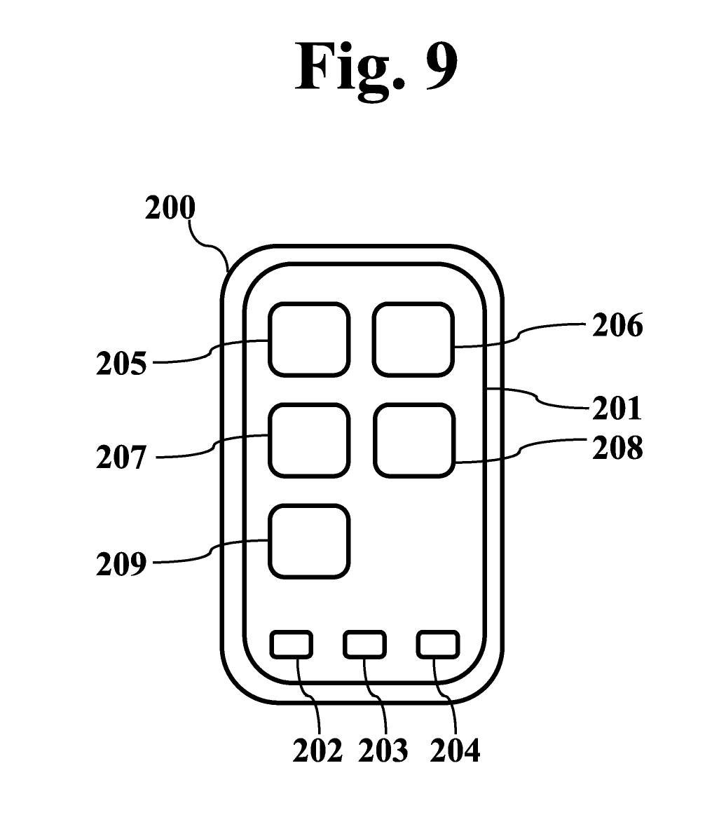

Turning now to FIG. 9, we see an illustrative rendering of an opened basket. The basket is viewed and manipulated via a user interface running in an apparatus [200] comprising a touch screen [201]. It preferably comprises a collection of buttons, illustratively [202]-[204], for performing various functions applying to all assets in the basket or just a subset of them, as will be discussed further below. It also displays representations of the assets captured in the current session [205]-[209]. These asset representations can preferably be used, via various gestures by the user, to edit each asset individually. For instance, swiping an asset representation might serve to delete the asset it represents from the current session. Tapping the representation might play the asset if it is a video or a sound recording, or enlarge it to full screen if it is an image or a text asset. Alternatively, each representation could be playing the asset continually, or presenting representative parts of the asset. Tapping (or double tapping, or some other gesture) might bring up a palette of more extensive editing controls applicable to the selected asset, such as controls to change the volume, duration, bit rate or other characteristics in the case that the asset is a sound recording, but a different set of controls in the case that the asset is of a different type, such as a video, image, or text. Preferably, the order in which assets will appear when they are finally packaged for transmission can be controlled by moving the asset representations relative to each other via, e.g., drag and drop.

As mentioned above, the controls [202]-[204] of FIG. 9 are meant to illustratively represent controls for actions which apply to all or some subset of the assets in the current session. Some non-limiting example actions which might be implemented are a) packaging actions, such as packaging all assets for sending as an email, SMS message, uploading to a given social network, and so on, b) modifying the characteristics of all assets of a given type, such as changing the resolution of all photo assets, c) opening a store of assets, such as a collection of stored images or videos, for the selection of further assets to add to the current session, d) ending the session and transmitting the accumulated session assets.

### An Alternate Session Editor

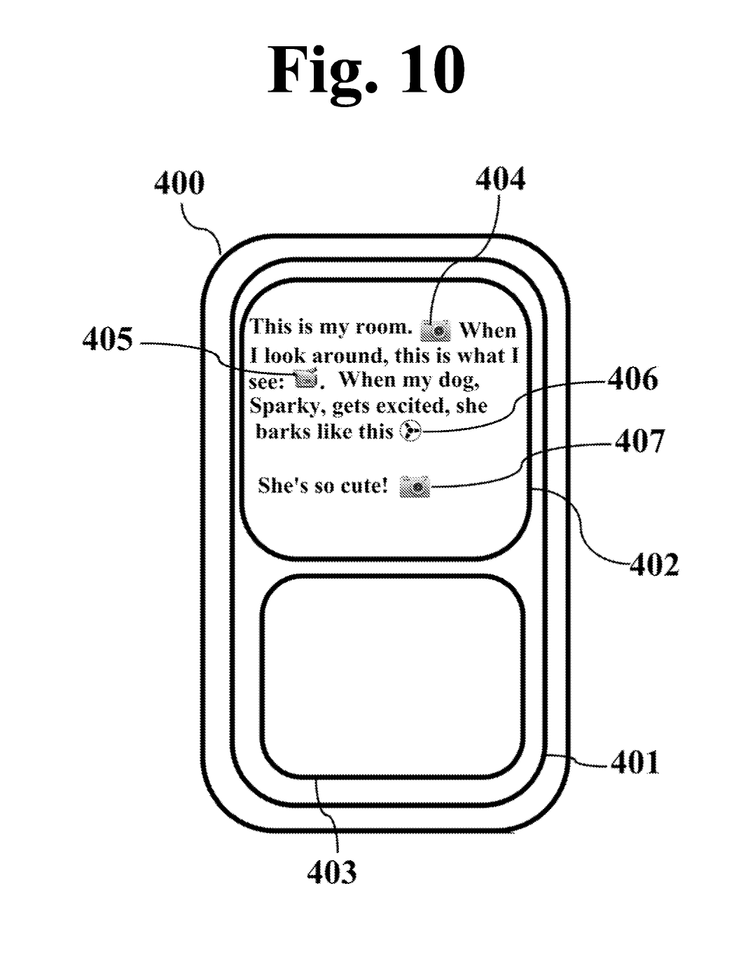

We now consider an alternate session editor which is designed as a “what you see is what you get” editor. This embodiment will be described in reference to FIG. 10. For non-limiting illustrative purposes, consider an embodiment of the present invention which is configured to insert non-text assets collected during a session at the current position of the cursor in the text. In other words, to create a “story” during a session, the user could type something and then create a media asset, a picture for instance, and an icon representing that picture would be inserted at the end of the current text. They could then continue typing, add another asset to be represented as an icon in the text and so on. In this way, the user could fluidly create a narrative using text or other assets as required. An example story created in this way is shown in FIG. 10. In this embodiment, an apparatus [400] comprising a touch screen [401] comprising two areas, a narrative area for displaying text and other assets collected during a session [402], and a keyboard area [403] in which a keyboard may be displayed. In FIG. 10, in the narrative area [402], assets creating during the current session are shown as icons placed within the text. For illustration, a photo is represented by a camera icon ([404] and) [407], a video is represented by a video camera icon [405] and a sound recording is represented by an icon of a reel of magnetic tape [406]. To create this narrative, the user typed “This is my room.” and then took a photo, which is represented in the text as [404] and then continued typing, then took a video [405], continued typing, and so on.

This representation could be transmitted to be displayed as shown for a receiver, given appropriate display software at the receiving end. Preferably, either sender or receiver could tap the embedded icons to start an appropriate viewer to see and/or hear the associated asset. Preferably, the sender (and/or receiver if the receiving device were so configured) could manipulate the icons in other ways. For instance, an icon could be deleted to remove the underlying asset. Icons could be dragged around in the text to change their position within the narrative. Further asset editing capability could be built into the software activated when a given icon is tapped or otherwise singled out by the user for editing.

### Addition of Existing Assets to a Basket

Preferably, assets can be added to a basket not only at the time of the creation of the asset, as we have previously discussed, but also at some later time. To add an existing asset to a basket, the user must a) identify the existing asset to be added and b) identify the basket to which the asset is to be added, in the case of multiple existing baskets. Well-known techniques for adding files to computer folders can be adopted for accomplishing these tasks. For instance, the identity of one or the other or both the asset and the destination basket could be typed in. Or an icon representing the asset could be dragged and dropped onto an icon representing the destination basket. Preferably, baskets share another characteristic with traditional computer file folders: they can be nested so that a basket may contain one or more other baskets.

### Asset Chemistry

### Baskets

A first concept of a basket was introduced above in reference to FIGS. 8-10. In those embodiments, assets were placed in the basket upon creation by the user. That creation comprised selecting time slices from a media feed in the case of images or sounds, or typing or using voice recognition in the case of text. In the following we will reveal how the function and utility of baskets is remarkably expanded though inventive features which we will particularly point out and explain.

### Baskets can be Active: The Combine and Combinable States

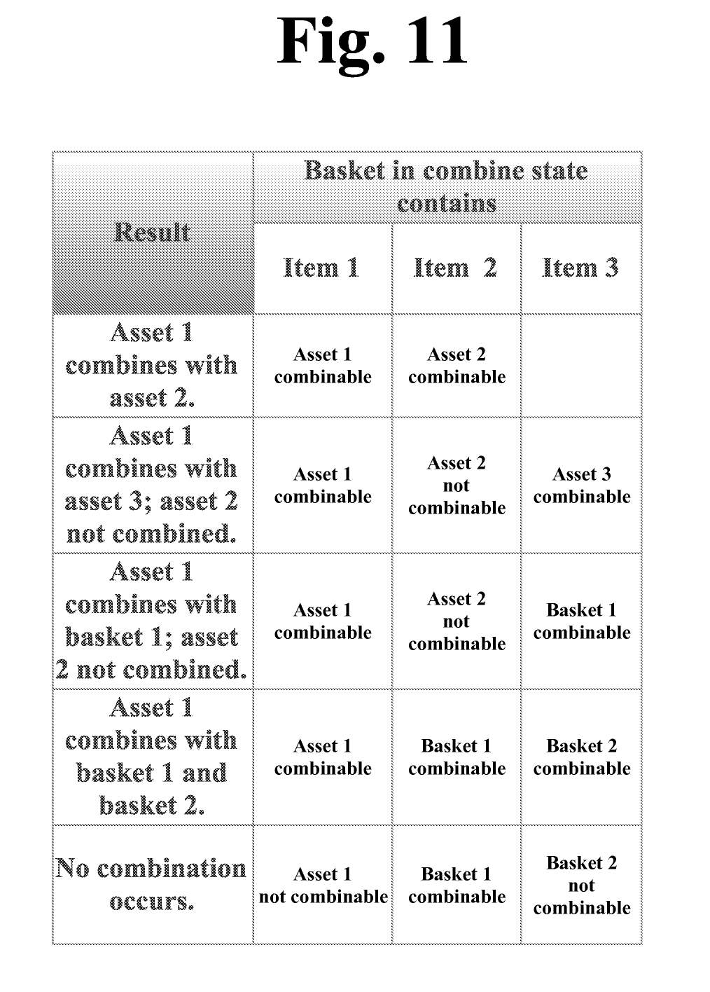

While a traditional computer folder is but a passive vessel for the files it contains, a basket can be active in modifying its own contents. A basket becomes active when it is put in the “combine” state. The assets themselves are also endowed with a new state, the “combinable” state. When a basket is in the combine state, any combinable assets in basket will be combined to form new assets. Preferably, a basket may also have a “combinable” state. When a basket is in its combinable state, the basket becomes a combinable asset such that it will combine with other combinable assets when it is placed in a basket in the combine state. The chart of FIG. 11 presents some of the possibilities opened up by these inventive concepts. In FIG. 11, we consider the fate of up to three items placed in a basket in the combine state. The result of the action of the basket on these items is given in the first column, and the items are described in the other columns. As can be seen from FIG. 11, in a basket in the combine state, any combinable assets or sub-baskets will be combined together (provided that an applicable combining rule is implemented, see below for details). Naturally, if there is only one combinable asset or sub-basket in a basket, no combination can occur.

### Basket Creation

Baskets may be predefined, created by the user, or created as a byproduct of some other action. We have already seen an example above of this last possibility, where a basket is created when the first asset of a session is created. The UI for creating a basket could resemble in part the well-known practice for creating folders for computer files, such as allowing the user to specify the path to a new basket. Since baskets differ from folders at least inasmuch as they have a combine property, which can be set on or off, and preferably, a combining property which can be set on or off, some mechanism is preferably provided to set these properties at the time of basket creation and/or to modify those properties at some later time. The default behavior and user interface (if any) for changing that default behavior will typically be chosen depend on the application. It will be appreciated that any such choice is within the scope of the appended claims. For illustrative, didactic, non-limiting purposes, we will define for this embodiment a procedure adapted to the presence documentation embodiments discussed above. Namely, there will be in this embodiment a top-level basket which is created to hold assets created during a documentation session. This top-level basket is created with both its “combine” and “combinable” flags turned off. Sub-baskets may be created within the top-level basket. Again, for the sake of illustration only, these sub-baskets, as well as any sub-baskets created within them and so on, will be created with the combine flag on, and the combinable flag off. As will be discussed further below, in this embodiment controls are provided for each basket permitting the user to change its combine and combinable properties.

Similarly, since assets themselves have a combinable property, default rules for setting the combinable flag of assets upon their creation, as well as a user interface for changing the state of the combinable flag are preferably provided. Unless stated explicitly otherwise, we will assume that assets placed in a basket with the combine flag on will have their combinable flag set on as well. Conversely, assets placed in a basket with the combine flag off will have their combinable flag set off. Thus, for example, in the embodiment in which the top-level basket contains assets created during a present documentation session, these assets will be non-combinable by default since the top-level basket is non-combining by default. However, if the icon representing one of these assets is dragged and dropped onto the icon of another asset, the resulting sub-basket containing the two assets will have its combine flag set on, and the combinable flag of each of the two assets will be switched on. This will cause the two assets to be combined, provided appropriate combining rules for assets of those types has been implemented.

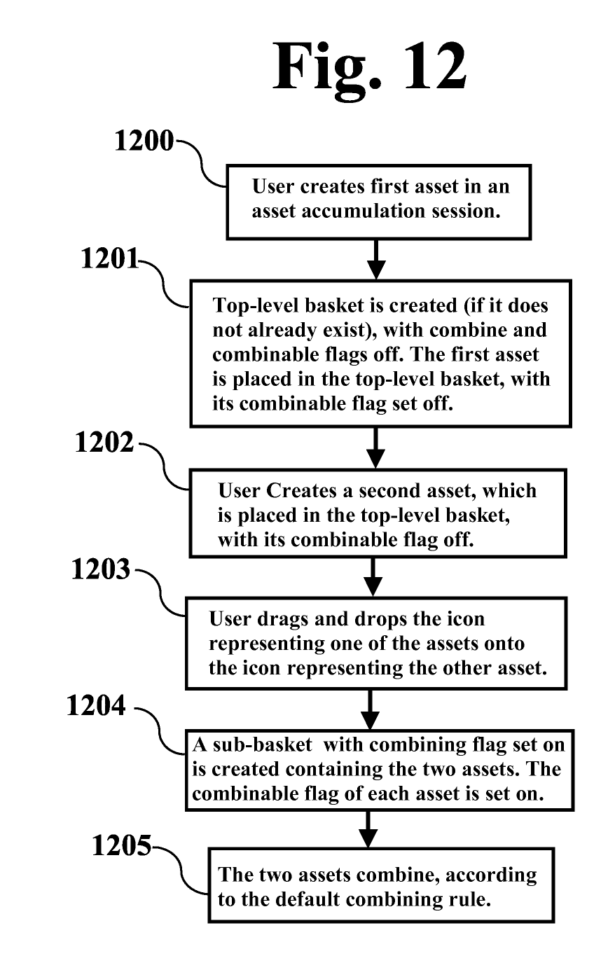

This scenario is represented in FIG. 12, to which we now turn. FIG. 12 shows a sequence of user actions and the response of an illustrative embodiment to those actions. resulting in the creation and operation of a basket hierarchy. The sequence begins at step [1200] when the user creates a first asset in an asset accumulation session. The system responds at step [1201] by creating a top-level basket (if a top-level basket does not currently exist) to hold the just-created asset. Both the combinable and combine flags of the top-level basket are set off. The first asset, now in the top-level basket, has its combining flag set off. The user then, at step [1202], creates a second asset, which the system places in the top-level basket, with its combining flag set off. At step [1203] the user (first opening the appropriate UI to view to contents of the top-level basket) drags the icon representing one of the assets over the icon representing the other asset and drops it. The system responds, at step [1204], by creating a new sub-basket. This sub-basket has its combining flag set on, and contains the two assets. The combinable flags of both the assets are set on. Thus, the system, at step [1205], combines the two assets, replacing the original two assets with the combined resulting asset in the sub-basket. Preferably, this combined asset also has its combinable flag on, such that if a third asset were added to the sub-basket, it would also be combined with the combination of the first two assets.

### Combining Rules

In order to combine two assets (or baskets), a rule (combining method) must exist for specifying how those two assets are to be combined. How, for instance, is one to combine a photo with another photo? Or text with a video? A priori, there are many ways to do it, and depending on implementation details, various systems may have different rules. In addition, it may be desirable to allow the user to override any pre-determine rules on an ad hoc basis, to control the method of combination of specified assets. In the following, a non-limiting illustrative set of rules will be described in detail. The set of rules to be described relate to assets of types text, image, video, and sound. Further types of assets may require further combining rules, and within an given type, there may be sub-types with variant rules. The illustrative set of rules we will describe produce a combined result which is also of one of the four basic types. We will use the notation type1::type2 to describe a combination or a rule of combination, so that “type1::type2” refers to a rule for combining an asset of type 1 with an asset of type 2. For the sake of illustration, all combining rules to be described below proceed according to the “and then” meta rule. To be applicable, the “and then” rule requires an order to be imposed on a collection of assets. For instance, the order could be the alphabetic order of the names of the assets. For illustration, we will use the order in which assets are added to a basket for implementing the “and then” rule. So, for instance, if the icon for a given asset has the icon for another asset dropped onto it, creating a sub-basket, the given asset is considered to be placed in the basket first, and the other asset placed in the basket second, so that the contents of the sub-basket are understood to be “given asset and then the other asset”.

This, then, is our first illustrative non-limiting catalog of combining rules:

### Video::Video

Two videos can be combined by simple concatenation, following the “and then” rule. The combination of two videos is also be a video, which consists of a first segment which is the first video, followed by a second segment which is the second video.

### Sound::Sound

Two sounds can be combined following a concatenation rule similar to the rule for combining two videos. The result is a sound, consisting of the first sound and then the second sound.

### Text::Text

Two texts can be combined into a single text by simple concatenation, which combined text comprises the first text and then the second text, with potentially a space or new line in between to prevent run-ons.

### Image::Image

Two images could be combined by concatenation into an image by making a bigger image containing each component image as a portion, or shrinking the component images to maintain the overall size at the size of the largest component, or some alternate default fixed size. The result would be similar to a proof sheet. To illustrate a rule in which the combination is of a different type than its components, we will adopt a default rule for image::image by which each image is converted to a video, and then combined following the video::video rule described above. In a typical implementation, the videos would be short, on the order of seconds, such that the combined video is similar to a slide show.

### Image::Video

The image::video rule we will adopt for illustration is similar to the image::image rule just described, except in this case just one image needs to be converted to a video. But the result of the combination is again a video, following the “and then” rule, so that, for instance, if the image is first, the resulting video shows the image for a time (typically a few seconds), followed by the video to which the image was combined.

### Image::Sound

One illustrative implementation of image::sound is to make the result of the combination be a video. The image forms the visual track of the video, and the sound forms the sound track. In the simplest form of this rule, the duration of the video is just the duration of the sound.

### Video::Sound

Illustratively, when a sound is combined with a video, the sound replaces all or part of the sound track of the video. When the sound is of a different length than the video, a default resolution may be applied. For instance, one could use the length of the shortest of the two, and truncate the longer one. Or use the longest length of the two, and either repeat the shorter one, or fill with whatever sound is already in the video sound track, or fill with silence (if the video is longer) or the last frame of the video or a blank image (if the sound is longer). For illustration, we will use the rule taking the longest length, and filling with silence or blank image as required, retaining copies of the original assets so that if further video and/or sound is to be concatenated with the first pair, the empty space can be filled all or in part by the further assets. See below for further discussion of combinations of more than two assets.

### Image::Text

There are many alternatives for this rule, and which is chosen as the default rule will depend on implementation. For instance, text can placed directly on an image, or could be combined with he image as a caption, where the text is rendered as an image next to, but not on the image to which the text is combined. For illustration, we will chose to place text directly on the image, where by default the text is centered on the image, and text color automatically chosen such that the text has good contrast with underlying image. A simple algorithm for selecting that color might be to take the color negative of all pixels in the bounding box of the text and compute the average. Alternatively, map the background pixels to a grayscale, take the average (or median), and chose white, black for the text color if the average (or median) is dark, light respectively. Alternatively, the text could be placed in a bounding box with the color, transparency, and other features of the background fill and the text itself chosen appropriately.

As will be discussed further below, preferably, editing controls are provided whereby the user can change the style and features of the image::text combination. The default itself could be made more complex, e.g. by having text and then image rendered with text on the image, but image and then text rendered as a caption.

### Sound::Text

Sound and text can be combined in a variety of ways. For the sake of illustration, we will chose to break the text into pieces, cutting at punctuation marks, a certain number of words per piece, or some other scheme. Then, using the image::text rule described above, we will make a video combining a plain background image with each piece of text. The plain background could be replaced by animations (e.g. an animation of a being speaking the text), stock images or images generated by some other method to complement the text. Illustratively, the length of the image::text videos will be the length of the sound divided by the number of pieces. Those videos are then concatenated using the video::video rule in the order the pieces appear in the original text, and the sound used as the sound track for the combined video using the sound::video rule.

### Video::Text

In general, there are many ways to combine text with a video. Text could be used as opening or closing credits, or as subtitles, or written across the center of the (moving) image, etc. For illustration, we will adopt the following rule: if video and then text, render the text as a closing credit, if text and then video, render the text as an opening credit.

By rendering as a credit we mean: follow the text:::image rule to make a video with the text on a plain background, and then append to the front for an opening credit, and to the end for a closing credit. For long texts, the text could be broken appropriately into pieces, to form multiple, concatenated, opening and/or closing credits. Note that an alternate method to combine text with video will be along the lines of the rule for combining text with sound. That is, the text would be broken into pieces, each piece appearing as a subtitle for a fraction of the length of the video.

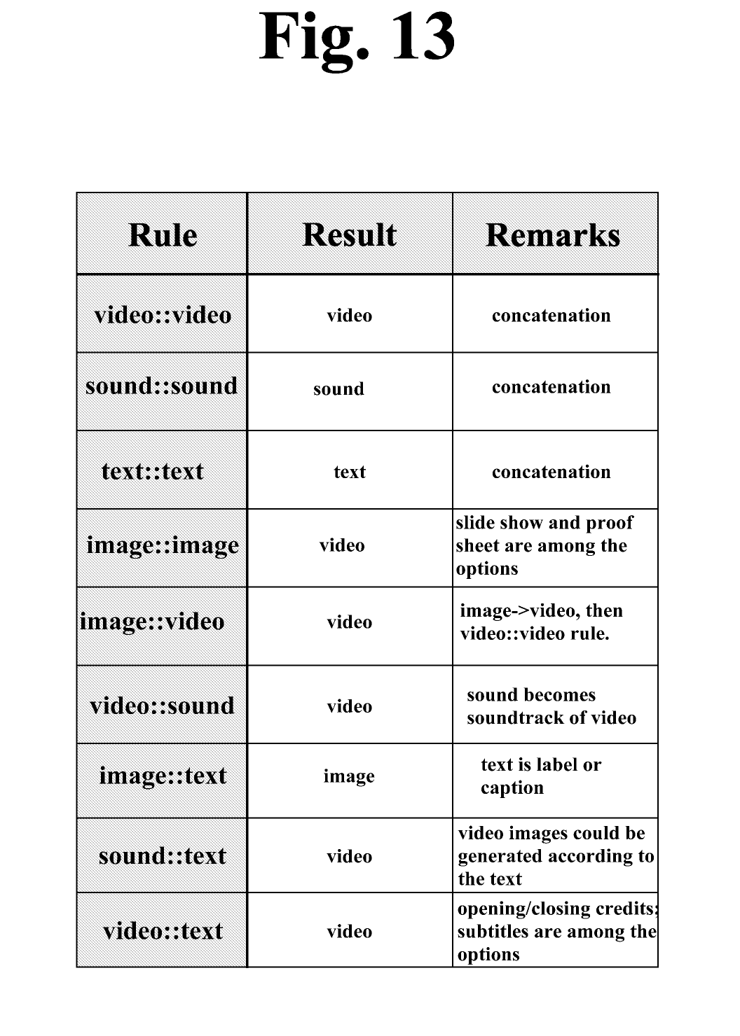

The illustrative combining rules described above are summarized in the table of FIG. 13. This table identifies the illustrative rules described above (in the first column) and given the type of the resulting asset (second column). In certain cases alternatives to the illustrative choices made above are remarked upon (third column). Further variants will be described below.

### A Personalized Closing Credit

This next embodiment shows that a video::text rule need not involve text entered at the keyboard by the user. Under this alternate rule, if a user fails to enter text for an opening and/or closing credit for a video, then a credit is created automatically from available data, such as the user's name and location, in addition to other known information such as the current time when the video was created, and the name of the software used. The template for the text might then be: “Directed by [UserName] using [SoftWare]. Filmed on location in [CurrentLocation] on [Date]”. This text could be presented on a photo of the user, or some other suitable image, the whole turned into a closing and/or opening credit according to this alternate video::text rule.

Combining Baskets with Assets and Other Baskets

We have seen that a basket, just like an asset, has a combining flag which can be set on or off. Baskets in the combining state can combine with assets and/or other baskets. The rules for doing so are inherited from the rules for combining base asset types. So, for instance, when a given basket with both its combine and combing states on contains a sequence of combining assets, that sequence of combining assets will be combined and the combination will have a certain type. The given basket will then combine with other baskets or assets following the rule relevant to type of the composition of the assets it contains. For instance, if the combing assets in a basket combine to make a video, then the basket combines as if it were a video; otherwise said, it acts as if it were identical to the combined assets it contains. The case where a basket contains both combining and non-combining assets and/or sub-baskets will be discussed below under the topic of basket export.

### Combining Arbitrary-Length Sequences of Assets

To combine a sequence of assets, it is generally sufficient to combine assets pairwise in sequence. That is, to combine asset1 and then asset2 and then asset3, first apply the rule for asset1 and then asset2 to form asset12, and then apply the rule asset12 and then asset3. However, in some cases, it is desirable to adjust earlier combinations in view of later additions to the sequence. An example of this has already been described for the combination of sounds and videos. Readjustment might also be desired in cases such as combining several texts to a sound. In this case, the time during which each piece of text is displayed while the sound is played may be reduced to accommodate additional text, keeping the length during which the sound plays the same. Similarly, when many assets of different types are to be combined, it may be desirable to combine this assets first by asset class, using the “and then” rule within the class, and then combine the asset classes according to the pair-wise rules given above. That is, for instance, all the sounds can be concatenated to form a single sound, all the videos combined to form a single video, and then the single sound and video combined using the sound::video rule.

### Combination of Landscape and Portrait Assets

A complication which may arise when various image assets are combined can also be resolved by a default rule. When image assets of different size format are to be combined, it is generally preferable for a single format to be chosen for the combination. For instance, when landscape and portrait orientation images assets are combined, the whole may be rendered in landscape or portrait. Illustratively, we will chose a rule by which the format of the first asset in the sequence determines the format for the entire combination. So that, e.g. if the first asset is in landscape mode, then the combined asset will also be in landscape mode. Similar defaults can operate for choosing the resolution, compression method, or other technical features of the combination.

### Video Creator

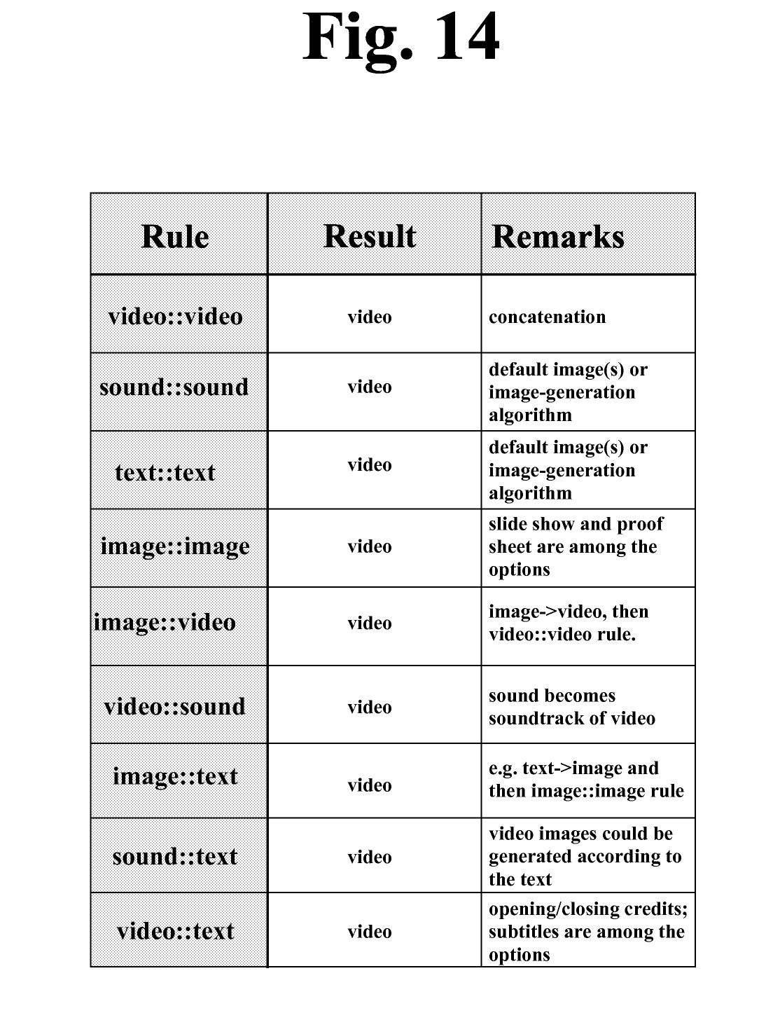

The set of combining rules summarized in FIG. 13, along with the rules for combining baskets which baskets inherit from the asset combination rules, tend to keep assets from combining with each other unless the user specifically requests combination, and to be generally conservative about creating videos when another format is closer to the source format. For the sake of illustration and contrast, an alternate set of asset combining rules is presented in FIG. 14. FIG. 14 presents information in the same format as FIG. 13. The set of rules of FIG. 14 aims to automatically create a single video on output, regardless of the types of the component inputs. Under this set of rules, all baskets are created with their combining and combining flags on. As a result, everything eventually combines with everything. The asset combining rules of FIG. 13 which do not produce a video on output are image::text, sound::sound, and text::text. These can be replaced in a variety of ways with combining rules which produce video on output, for instance as follows: Image::text can produce video on output by converting the image combined with its text to a (typically short) video, Similarly, sound::sound can have a video on output if the output concatenated sounds are paired to a blank video track, a video track showing animations or wave forms responsive to the sound track, or some other default automatic video creation method. Even text::text could be made to produce a video on output, where the video is simply a blank background for the text distributed piece by piece over time, or some algorithmically generated moving images, such as an animation of a person or other being speaking the words of the text.

To facilitate and automate the creation of a single video from diverse outputs, the default behavior of the baskets will also be modified for this embodiment. Here, all baskets, including the top-level basket are created with their combine and combinable flags set on by default. In addition, all assets placed in the top-level basket or any of its sub-baskets will have their combinable flag set on. These settings, combined with the asset (and thus basket) combination rules ensure that regardless of the mix of types of input assets, all will be combined to form a single video. (Assuming, of course, that only asset types for which combining rules are defined are placed in the basket hierarchy.)

In this embodiment, even though all assets are eventually combined with each other to form a single output video, a basket hierarchy may have an advantage over a single basket since it may permit the user to control the manner in which assets are combined. To accomplish this, an additional default rule is imposed: assets within a given basket are first combined with each other, and then the result is combined with other assets in the parent basket, and so on up to the top-level basket. The operation of such a rule will be shown further in the next section in the context of the export of a basket hierarchy.

### Export of a Basket Hierarchy

The bottom-up rule for the combination of assets in a basket hierarchy just described can be applied to embodiments in which assets and sub-baskets are heterogeneously combinable, combining, or not. Such a rule is beneficial especially in the case where the hierarchy of baskets is to be exported via some medium, such as email, which does not implement support for a basket hierarchy and can only transmit assets sequentially. Any rule which transforms the hierarchy into a flat sequence would be sufficient for this task, but different rules will potentially give different sequences from the same hierarchy of baskets. For the sake of illustration, we will describe a particular rule which incorporates both level in the hierarchy of baskets, and order of the assets in a basket. There are many ways to provide a sort order for assets and baskets of assets. We have already mentioned one way in which assets can be given an order: by time of adding to the hierarchy. A basket can be placed in order by its time of being added to the hierarchy, or it could take the time of the oldest or newest asset it contains for determining its place in the order. Similarly, when assets are combined, they can take the time of the first asset or the last asset in the combination, or an average, or some other method.

Once the order is defined, collapse of the hierarchy can proceed, for instance, as follows: beginning at the lowest level of the hierarchy, all combinable assets in each basket at that level of hierarchy are combined and ordered with respect to the non-combinable assets in the basket. That creates a collection of sub-sequences, one for each basket at that level. Then the subsequences are arranged relative to each other according to the order of the baskets at that level themselves. The process then continues to the next higher level of the hierarchy until the top level is reached. At that point, all the assets, combinable or not, are arranged in a sequence.

### A Worked Example of a Basket Hierarchy Collapse

We will now work through in detail an illustrative non-limiting example of the collapse of a basket hierarchy into a linear sequence, using the set of rules we have adopted for illustration. This example is an existence proof that a mapping from hierarchy to sequence exists. Other rules will give other resulting sequences, but any such set of rules remains within the scope of the appended claims.

### Notation

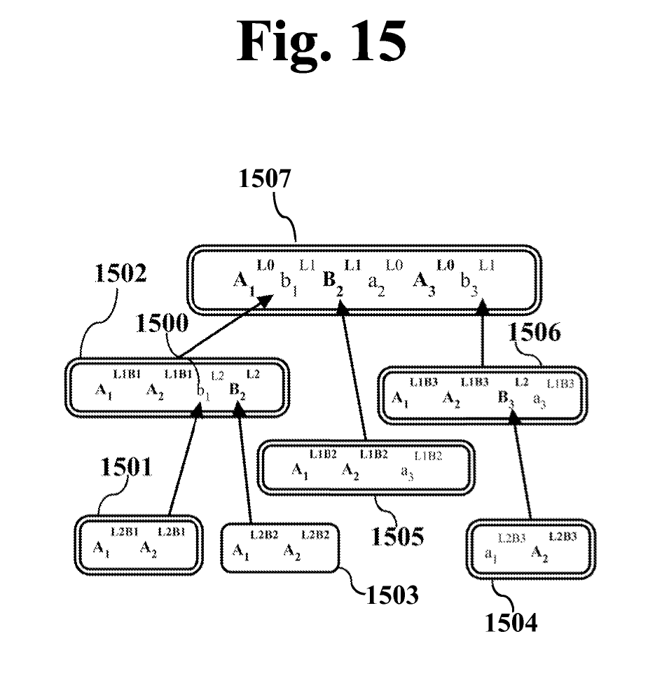

Some notation is helpful for the detailed description of this example. A will denote an asset, B a basket. A,B are written in upper case, bold, if the asset resp. basket are combining, and in lower case, regular font, if they are not. Thus “A” is a combining asset, and “a” is a non-combining asset. In FIG. 15, there are three levels in a basket hierarchy, level 0 to level 2, reading top to bottom. The level and basket in which an asset originally exists is denoted in superscript, and the order of the asset in the basket is denoted in subscript, thus A₁^{L1B2} is a combining asset, it is the first asset in the second basket at level 1. Baskets are shown both at the level at which they are defined, and as an icon in the higher-level basket which contains them. For example, [1500] is a representation of basket [1501] at level 2 in its super-basket [1502] at level 1. At its own level, the basket is represented as a shape, with a double border if it is in the combine state (the basket will combine combining assets or baskets it contains), and a single border if it is not a combine basket. So, for instance, [1501] is a combining basket and [1503] is not. As an icon in a basket at the next highest level, the given basket is represented by a “B” if it is in the combine state (will combine with other combining assets or baskets if the basket which contains the icon is combining) or “b” if it is not a combining basket. A superscript on the icon gives the level at which the basket exists in the non-collapsed hierarchy. Thus B₃^{L2} is the icon of the third basket from level 2 in the non-collapsed hierarchy, where said third basket at level 2 is a combining basket [1504]. The same basket would be represented as b₃^{L2} if it were non-combining.

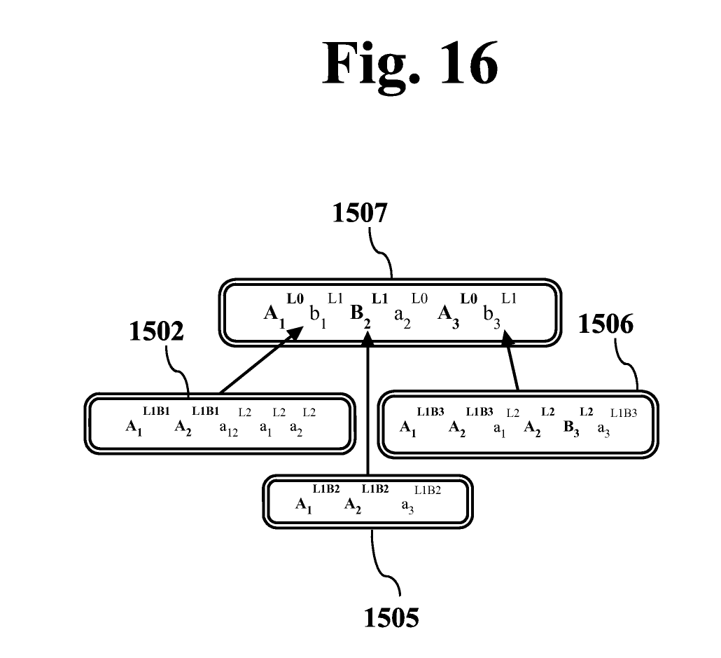

At FIG. 16, the state of the hierarchy after the lowest level, level 2, has been collapsed into Level 1. By “collapse” of level 2, we mean that any combining rules that can be applied to assets at level 2 have been applied, resolution of the combining/combine flags of the baskets at level 2 has been made, and the icons for the level-2 baskets have been replaced with the assets formerly at level 2, with the combining rules applied. These level 2 baskets are the baskets [1501] [1503] and [1504] in FIG. 15. In the collapse process, all of the assets of these level-2 baskets are moved to the respective super-baskets, with any applicable combining rules applied.

### First Level-2 Basket

The first basket at level 2 (basket L2B1, [1501]) is a combining basket, as denoted by the double border of its shape in FIG. 15. It contains two combining assets. In the collapse process, these two assets are combined to form the combination denoted a₁₂^{L2} found in FIG. 16 in the first basket of level 1 [1502], which is the super-basket of [1501]. Note carefully that the combined asset is not subject to further combination, since the basket 1 at level 2 [1501] is combining, but not combine. That is, it is set to combine assets it contains, but to not combine further once that happens. The icon for basket 1 at level 2 [1501] is denoted b₁^{L2} in FIG. 15, and is then, in FIG. 16, replaced with the combined asset a₁₂^{L2} found in basket [1502].

### Second Level-2 Basket

As seen in FIG. 15, the second basket at level 2 [1503] is non-combining, that it, it does not combine assets it contains whether they are set to be combining or not, but it is set to combine itself, as a whole. In the set of default rules we are adopting here for illustration, in the case of conflict, non-combining of a basket dominates the combing properties of the assets or baskets it contains. That is, combining assets in a non-combine basket do not combine, even if the basket itself would combine as a whole. In an alternate embodiment, in the case of conflict, combining of the basket could dominate non-combining of the things the basket contains. If that were the rule, then during the collapse process, any combining assets would rise in the hierarchy with their combining flag remaining on, until they are in an environment in which they could be combined. The resolution of the combine/combining flags in the present embodiment case is that the icon B₂^{L2} in basket [1502] of FIG. 15 is replaced with the pair a₁^{L2} a₂^{L2} in basket [1502] of FIG. 16. This is a pair non-combining assets, placed in the order they had originally, in basket [1503] of FIG. 15.

### Third Level-2 Basket

Now consider basket 3 of level 2 [1504] in FIG. 15. This basket is combining, and contains one combining and one non-combining asset. Since there is only one combining asset, there is nothing for it to combine with in basket [1504]. Since the basket is combining, and is also “combine” (the basket will combine as a whole), there is no conflict: collapse of the baskets consists simply of transporting these two assets to the super basket, basket 3 of level 1 [1506], where the basket icon (B₃^{L2}) is replaced by the assets a₁^{L2} and A₂^{L2} (the B3 superscript dropped to simplify). The combining asset from the sub-basket [1504] (A₂^{L2}) is now free to combine with other combining assets in the super basket [1506].

### First Level-1 Basket

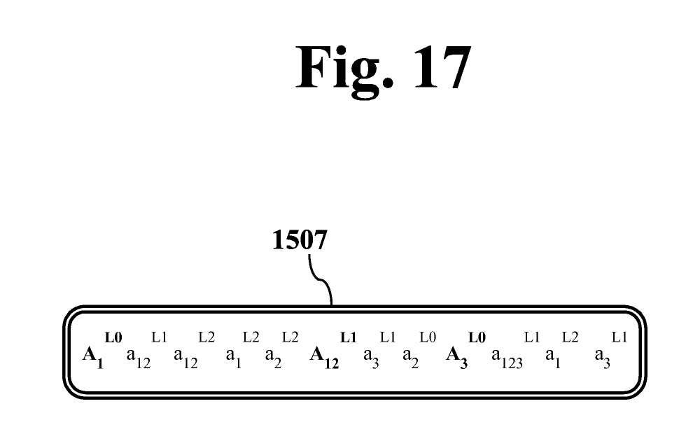

At FIG. 17, we proceed by collapses the level-1 baskets into the level 0 basket, level 0 being the final (top) level.

We begin with basket 1 of level 1 ([1502], in FIG. 16). This basket is “combining” and “not combine”. It combines combinable assets within it, but does not undergo further combination at a higher level. At FIG. 16, basket 1 of level 1 [1502] contains two combining assets, and three non-combining assets. At FIG. 17, the two combining assets are combined with each other, to form asset a₁₂^{L1}, which is placed in order in the top-level basket [1507] along with the other (non-combining) assets from basket 1, level 1 [1502], in their order as was defined in [1502].

### Second Level-1 Basket

Turning then to basket 2 of level 1 (FIG. 16, [1505]), we see that it is both “combining” and “combine”. Thus any combining assets it contains will be combined with each other, and, once that combination occurs, further combination may occur with combining assets at a higher level. Basket 2, level 1 [1505], contains two combining assets, which combine with each other to form asset A₁₂^{L1} in [1507]. This combined asset, along with the non-combining asset a₃^{LIB2} from [1505], is placed in the level-0 basket [1507] in FIG. 17. Note that the combination A₁₂^{L1} remains combining at level 0 since it finds itself in an environment [1507] which is also in a “combine” state; the “combining” chain remains unbroken.

### Third Level-1 Basket

Now we consider basket 3 of level 1 (FIG. 16, [1506]). It is “combining” and “non combine”. Since it is combining, all the combining assets it contains (namely A_{1L}^{1B3} A₂^{L1B3} A₂^{L2}) are combined, into a combination which we will denote a₁₂₃^{L1}, a combination which itself does not combine, since the basket [1506] is not “combine”. The non-combining assets from [1506] (namely a₁^{L2} and a₃L^{1B3}) are placed in order in the level-0 basket, replacing the basket icon b₃^{L1} as shown in FIG. 17.

### Level 0

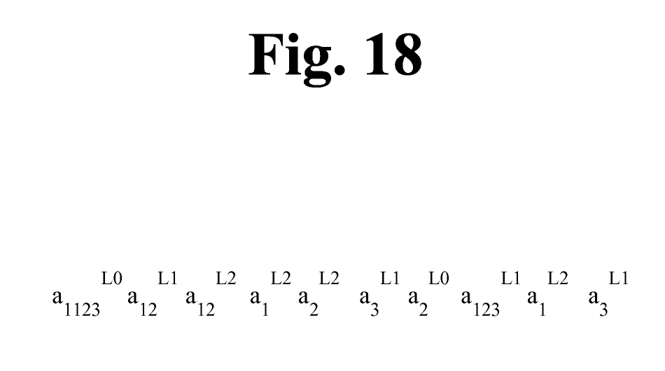

Next, the final transformation takes place, resulting in the state shown in FIG. 18. The level-0 basket is combining, and at the pre-combination state shown in FIG. 17, it contains three combinable assets, namely A₁^{L0} A₁₂^{L1} and A₃^{L0}. We will call the resulting combination a₁₁₂₃^{L0}, adopting the non-combining notation since no further combination can occur. FIG. 18 shows the state where the hierarchy of baskets has been entirely collapsed into a single sequence, and all combinations which can occur have occurred. While there were 17 assets and 7 baskets in the original hierarchy, there are now only 10 assets, and no baskets. Note that since we are adopting, for illustration, the rule that a combination takes the order of its earliest component, this combined asset is placed at the beginning of the sequence, where the combining asset A₁^{L0} was, pre combination. Finally, note that we have applied another illustrative rule, that combining assets combine in combining assets even when non-combining assets intervene in the order. An alternate embodiment might adopt the rule that non-combining assets do not allow combinations to occur across non-combining assets and/or baskets.

### Basket Editing

Editors for individual asset types are well known in the art. These include photo editors, video editors, sound editors, text editors and so on. Any editing operation applicable in an individual asset type could be applied in the context of a basket hierarchy. This section will focus on novel and surprising editing operations made possible and useful by the inventive concepts described above pertaining to baskets, default combination rules, and, generally, the combination of assets. The new editing opportunities include without limitation
1) ad hoc editing of combining rules; undoing the action of combining rules,
2) changing the combining flag of baskets and assets and the combine flag of baskets,
3) creating and deleting baskets,
4) changing the order of assets and baskets within a basket,
5) rearranging basket hierarchies,
6) changing basket hierarchy collapse rules, and
7) changing packaging/export rules.

An emphasis has been placed throughout on supplying defaults for all operations, so that a user can concentrate on content creation rather than formatting. However, editing of arbitrary finesse and complication may be provided within the scope of the appended claims.

### Illustrative UI for a Basket Hierarchy

You can a priori do several things with a basket, including without limitation

1) open it to view it contents,
2) change its combine and combining flag,
3) change the combining rules it may apply to combinable assets it contains,
3) move it around relative to other things in the same super-basket,
4) reorder the assets and sub-baskets it contains,
5) delete it or otherwise edit its position in a basket hierarchy,
6) add a sub basket to it,
7) add or remove assets from it,
8) “play” it. Where “play” means apply all its combining rules (and perhaps, recursively in all its sub-baskets), and show the result.

We have already discussed user interfaces for performing some of these functions on a touch-screen device in reference to FIGS. 9 and 10. In the illustrative UI to now be discussed, for the sake of further exploring the scope of the appended claims, we will illustratively focus instead on a basket editing on a traditional desktop computer, a computer equipped with a keyboard, a mouse, and graphical user interface. Application of this disclosure to other hardware, such as a touch screen, will be evident to ones skilled in the art once they have become enlightened by the teachings herein.

### Single Basket View

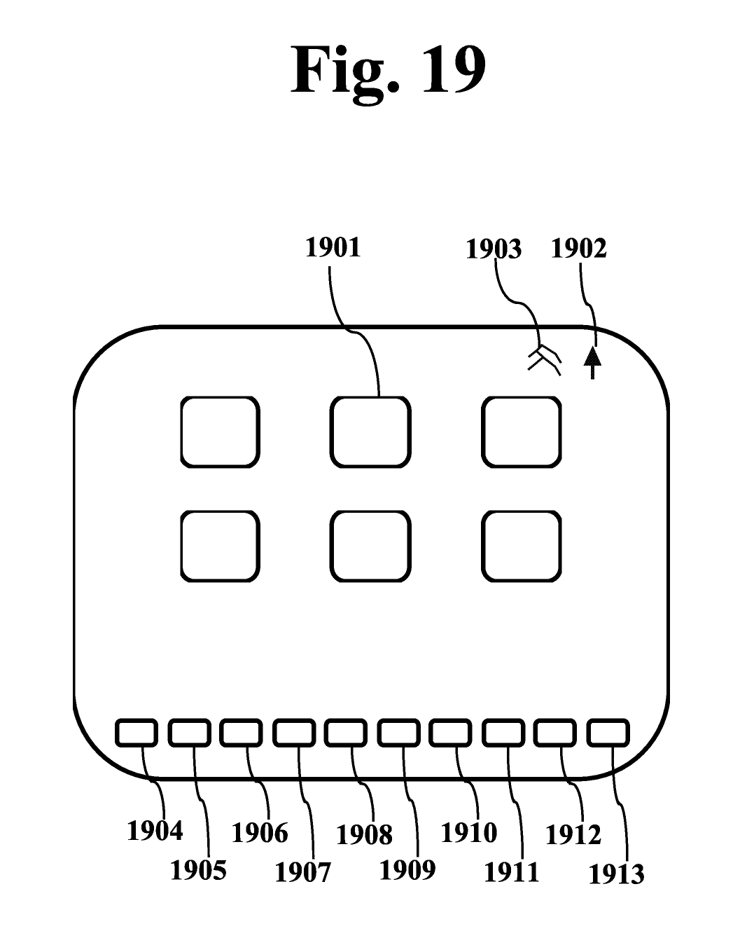

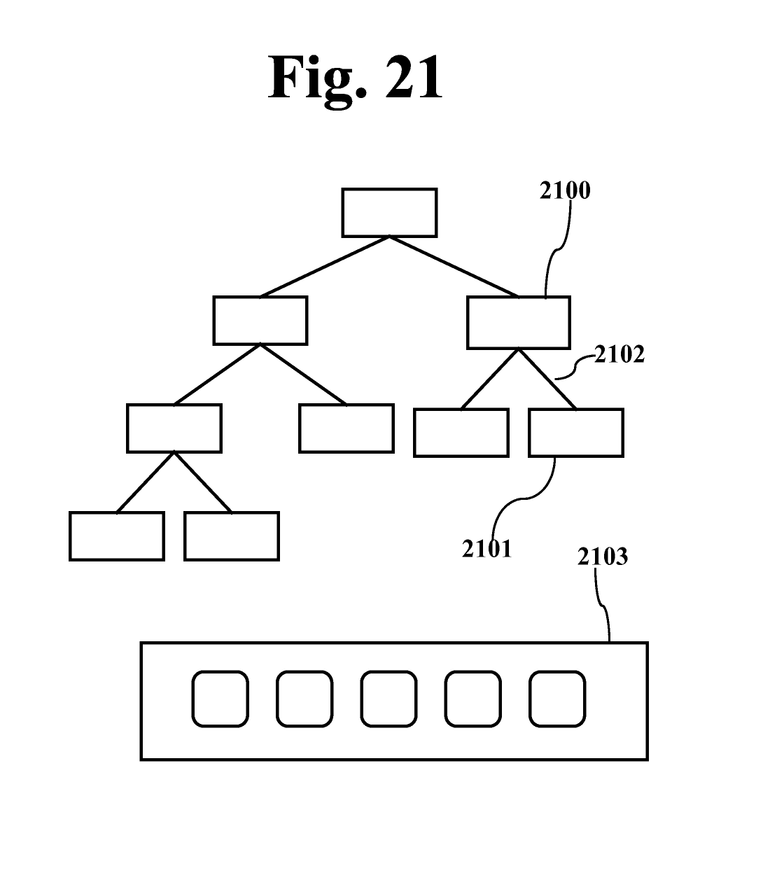

An illustrative single-basket view is shown in FIG. 19. Each asset or sub-basket the basket contains is represented by an icon. A representative icon is indicated in FIG. 19 as [1901]. Assets and sub-baskets may be moved around relative to each other by dragging and dropping their icons, or a selected subset of icons, with the mouse. A sub-basket can be opened by double clicking on its icon, with the view of that sub-basket replacing the view of the current basket. Activating the control [1902] replaces the view of the current basket with a view of the super-basket which contains the current basket. Activating the control [1903] replaces the current single basket view with a tree view of all or a portion of the basket hierarchy. This tree view will be discussed below and in detail in reference to FIG. 21. Other global views of the basket hierarchy, such as in the form of cascading lists may be obtained in some embodiments using still further controls.

The interface of FIG. 19 has a collection of buttons [1904-1913] for performing actions, either on the basket as a whole, on a single asset or sub-basket, or on a subset of assets and/or sub-baskets. For illustration, any of these buttons can be activated by clicking on them with a mouse, or by hitting an associated function key, or some other keyboard shortcut. For instance [1904] may be used to toggle the “combine” flag of the basket, and [1905] may be used to toggle the “combining” flag of the basket being currently viewed. [1906] is used for changing the combining rules applicable to the basket being currently viewed. When it is selected, a menu of applicable rules is presented. Rules can be selected or deselected from the menu. Alternates for a given rule may be selected from sub-menus from this first menu. [1907] is used to delete a selected asset or sub-basket, or a selected subset of assets and/or sub-baskets. [1908] is used to toggle the “combining” property of a selected set of assets and/or sub-baskets. [1909] is used to toggle the “combine” property of a selected set of sub-baskets. [1910] is an edit button, which invokes an editor appropriate to the type of the asset currently selected. [1911] allows new assets to be added to the basket, either by newly capturing them or by importing existing assets. [1912] is “play”. When “play” is activated, a selection of assets and/or sub-baskets (or the entire basket if no selection is made) is played, meaning that all applicable combining rules are applied, and the resulting assets are shown to the user, via their asset-type-appropriate viewers, in the sequence they would appear on export. [1913] adds a new sub basket. Preferably, new baskets may also be created by dragging and dropping one asset on to another one, creating a sub-basket which contains both. It should be appreciated that while we have described this illustrative interface in reference to a display for a desktop computer, it could be adapted for use on a touch screen, and otherwise modified in ways known to those skilled in the art, and yet remain within the scope of the appended claims.

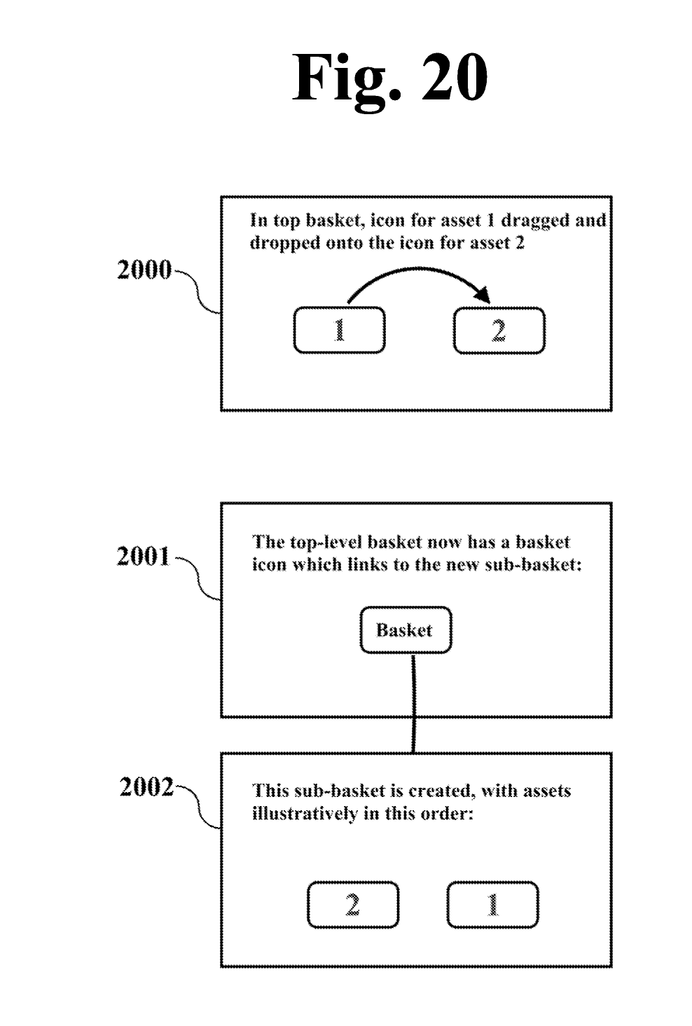

The process of dragging and dropping an asset onto another to create a sub basket is described in more detail in reference to FIG. 20, to which we now turn. The panel [2000] of FIG. 20 shows a basket containing two assets, icons for which are labeled 1 and 2. The arrow indicates that the icon for asset 1 is dragged and dropped onto the icon for asset 2. For illustration, the “and then” rule is interpreted in this context as implying that first there was asset 2, and then asset 1 was dropped on it, so that the sub-basket which is created from this process will contain asset 2, asset 1 in that order. This is shown in panel [2002]. Panel [2001] shows that the basket of panel [2000] now contains a single icon, which represents the newly created sub-basket. Depending on the relevant default rules, the newly created sub-basket may be combining or not, combine or not.

### Tree View

The tree view will be discussed in reference to FIG. 21, to which we now turn. The tree view of FIG. 21 presents the basket and sub-basket relationships in the entire basket hierarchy, or some subset thereof. Individual baskets are represented in FIG. 21 as rectangles, for instance [2100] and [2101]. The basket/sub-basket relationships in the tree are represented by straight lines connecting baskets, so that, e.g. [2102] indicates that [2101] is a sub-basket of [2100]. The tree view permits a variety of manipulations which would be difficult or impossible using only the single-basket view of FIG. 19. For instance, by dragging and dropping a single basket or a sub-tree of baskets, that basket or sub-tree can be detached from one position in the tree and re-attached at another position. Many of the operations applicable to a single basket as discussed above in reference to FIG. 19 can here be applied to the entire tree or a part thereof. These operations include without limitation, deleting or creating new sub-baskets, changing combination rules, toggling combine and combining flags, editing and playing. These operations can be performed using, e.g., a collection of buttons schematically represented in FIG. 21 as [2103]. Certain other operations are best conceived as applying to the hierarchy as a whole. For instance, one or more of the buttons in the collection [2103] could be used to chose the export target. That is, is the hierarchy to be saved to local memory, uploaded to a remote server, or sent as an email attachment? Depending on the export target, the hierarchy may be collapsed and otherwise prepared differently. The packaging itself may have parameters which could be adjusted using one or more of the buttons in collection [2103]. For instance, if the hierarchy is to be combined into a single video, the overall length of the video may be set to a fixed length in time, or to a fixed size in bytes, or to have a specified aspect ratio and encoding method. If the hierarchy is to be sent as email, then the assets within the hierarchy may be attached themselves, or may be uploaded to a server, and only a link to them attached to the email. In general, any aspects which apply most naturally to the hierarchy as a whole rather than any particular basket within the hierarchy may preferably be controlled in a tree view, or some other global view, rather than an individual-basket view such as the one discussed in reference to FIG. 19. It should be clear that a given basket hierarchy might be packaged in a variety of ways to be exported multiple times through different channels, and that no matter how packaged for export, a copy of the original hierarchy, in a form suitable for further editing and/or repackaging could be retained.

What is claimed is:

1. An apparatus comprising a touch screen, a central processing unit, an activatable internet connection, where said apparatus permits a state in which said touch screen displays an image feed on a first portion of said touch screen along with a simultaneously displayed keyboard on a second portion of said touch screen, said apparatus further comprising a control such that using said control, a user can take a time slice from said image feed in said first portion of said touch screen, to be combined with text, if any, entered with said simultaneously displayed keyboard in said second portion of said screen, said time slice and said text packaged by a packager operating in said central processing unit for sending via said internet connection and then sent via said internet connection at a point in time where said internet connection is active.

2. The apparatus of claim 1 further comprising a camera where said camera may selectable supply said image feed.

3. The apparatus of claim 1 where said simultaneously displayed keyboard can be dismissed and reinstated by said user.

4. The apparatus of claim 1 where said apparatus operates on a session basis, such that upon being given a session-end instruction from said user, all non-deleted media slices collected during a current session and all non-deleted text input on said superimposed keyboard during said current session is packaged as a message representing that session, said package suitable for transmission as a message.

5. The apparatus of claim 1 where said simultaneously displayed keyboard on said second portion of said touch screen is entirely surrounded by and within said first portion of said touch screen displaying said image feed.

6. The apparatus of claim 1 wherein said control for taking a time slice of said image feed can take either a photograph, which is an instantaneous time slice, or a time-segment image covering a finite period of time, such as a video or a photographic burst, such that when said control is first activated both a photograph is taken and the collection of a time-segment image is begun, if the time said control is activated exceeds a threshold, said instantaneous time slice is discarded and said time-segment image retained, otherwise said time-segment image is discarded and said instantaneous time slice retained.

7. The apparatus of claim 6 in which the frame rate of said time-segment image can be continually adjusted using said control for taking a time slice, for instance by moving the control in one direction to speed up and in another direction to slow down said frame rate.

8. The apparatus of claim 4 further comprising a basket which is configured to contain media assets collected during said current session.

9. The apparatus of claim 8 further comprising a user interface element allowing a user of said apparatus to open said basket so as to reveal representations of said media assets collected during said current session.

10. The apparatus of claim 9 further comprising a user interface permitting said user to edit said collection of said media assets, said editing comprising operations of deleting, playing and combining said media assets by manipulation of said representations.

11. The apparatus of claim 9 where said representations of said media assets are arranged in a story-telling arrangement where non-text media assets are represented by icons interspersed in text media assets, if any, so as to advance and enhance said story telling as expressed in said text media assets.

12. The apparatus of claim 1 further comprising combination rules describing how said media assets may be automatically combined by said packager to create new said media assets.

13. The apparatus of claim 1 further comprising one or more baskets, said baskets arrangeable in a basket hierarchy, and each of said baskets capable of being placed in a combine and/or a combinable state by setting of combine and/or combinable flags.

14. The apparatus of claim 13 in which said media assets may be in a combinable state, such that when said media assets are in a combinable state and placed in a said basket in said combine state then when said packager is run, said combinable assets in said basket in said combine state will be combined according to a set of pre-determined combining rules.

15. The apparatus of claim 14 in which a user of said apparatus may edit said basket hierarchy, said editing including the actions of setting combine and combinable properties of said baskets and said media assets, deleting said baskets and said media assets, creating new said baskets, moving said media assets and said baskets from one of said baskets to another, and importing said baskets and said media assets from other sources into said basket hierarchy.

16. The apparatus of claim 14 in which two of said media assets may be combining by dragging and dropping an icon representing a first said media asset onto an icon representing a second said media asset whereby a sub-basket is created which contains both said first and second said media assets, where said sub-basket is created with its said combining flag set on, and said combinable flag of both said first and second said media assets is set on.

17. The apparatus of claim 14 in which said packager packages combinable said media assets in said baskets provided said baskets have their combine flag set on, said packager combining said media assets according to a set of pre-determined rules specifying how said media assets of each type are combined with said media assets of the same or different type.

18. The apparatus of claim 17 in which said packager packages said basket hierarchy in a bottom-up fashion, combining or not said media assets and said baskets at level n in said basket hierarchy, according to said set of combining rules and the setting of said combine and said combining flags of said media assets and said baskets at said level n of said basket hierarchy, before proceeding to package said media assets and said baskets at level n−1 and so on up to the top level of said basket hierarchy.

19. An apparatus for presence documentation providing a mechanism for first starting an accumulation session, then during said accumulation session accumulating heterogenous media assets recording aspects of the users current physical environment, ending said accumulation session and then automatically combining said heterogeneous media assets by a packager which packages said accumulated media assets into a package suitable for transmission as a message.

20. The apparatus of claim 19 further comprising a mechanism for recording expressions of said user's internal state, such as in the form of text or audio, such that when said packager operates to combine said heterogeneous media assets recording said users physical environment into said package, said packager further combines said expressions of said user's internal state with said heterogeneous media assets in said package.
